(19) United States
(12) Patent Application Publication
(10) Pub. No.: US 2007/0131137 A1
(43) Pub. Date: Jun. 14, 2007

(54) Non-aqueous ink composition for inkjet

(75) Inventors: Takaya Kitawaki, Izunokuni-shi (JP); Masashi Hiroki, Yokohama-shi (JP); Hiroshi Kiyomoto, Hiratsuka-shi (JP)

Correspondence Address: FOLEY AND LARDNER LLP;SUITE 500, 3000 K STREET NW, WASHINGTON, DC, 20007, US

(73) Assignee: TOSHIBA TEC KABUSHIKI KAISHA

(21) Appl. No.: 11/297,397

(22) Filed: Dec. 9, 2005

(51) Int. Cl. C09D 11/00; C09D 11/02

(52) U.S. Cl. 106/31.6; 106/31.66; 106/31.86; 106/31.62

(57) ABSTRACT

A non-aqueous ink composition for an ink jet is disclosed which includes a pigment, a dispersant and a non-aqueous solvent. The non-aqueous solvent contains at least 70% by weight of a vegetable oil.

### BACKGROUND OF THE INVENTION

1. Field of the Invention

The present invention relates to a non-aqueous ink composition for an ink jet.

2. Description of the Related Art

In recent years, a recording apparatus using an ink jet system is widely employed in various fields, including general-use recording apparatuses, and recording apparatuses used in offices and industry. In the recording apparatus utilizing the ink jet system, an aqueous, non-aqueous or UV ink is used depending on the field of use of the recording apparatus. Particularly, the aqueous ink is cheap and safe and, thus, is used widely. However, in the application for high speed printing, the drying speed of the aqueous ink is low. In addition, where the aqueous ink is used for the printing on an ordinary paper sheet (PPC paper sheet), the paper sheet is cockled after the ink is dried, i.e., a so-called “cockling phenomenon”. On the other hand, UV ink is cured promptly upon irradiation with an ultraviolet light and, thus, is adapted for the application to the printing on a non-absorptive media or to a high speed printing. However, in the case of using the UV ink, it is necessary to use a large ultraviolet light irradiating apparatus requiring a large power consumption.

On the other hand, where a non-aqueous ink is used for the printing on an ordinary paper sheet, the ink droplet discharged from the ink jet head permeates promptly into the inner region of the recording paper sheet in a short time after the landing of the ink droplet on the recording paper sheet. As a result, a high speed printing can be performed without necessitating a special mechanism so as to obtain a satisfactory printed image without giving rise to the cockling phenomenon.

### BRIEF SUMMARY OF THE INVENTION

Usually, printed images are held in a transparent file for the storing of the printed image in an office or home. The transparent file used in the office or home is a file made of PP (polypropylene). In many cases, the PP film is swollen so as to be cockled if the printed image obtained by the printing with a non-aqueous ink is held in the PP file. In some cases, the PP film is heavily deformed such that the deformation amount of the PP film exceeds 1 mm so as to break the film.

An object of the present invention is to provide a non-aqueous ink composition for an ink jet, which does not swell nor deform appreciably the transparent file used for storing the printed image in the office or home and which ensures a high discharging stability.

According to an aspect of the present invention, there is provided a non-aqueous ink composition for an ink jet, comprising a pigment, a dispersant, and a non-aqueous solvent, wherein at least 70% by weight of the non-aqueous solvent is vegetable oil.

Additional objects and advantages of the invention are given in the description which follows, and in part will be obvious from the description, or may be learned by practice of the invention. The objects and advantages of the invention may be realized and obtained by means of the instrumentalities and combinations particularly pointed out hereinafter.

### DETAILED DESCRIPTION OF THE INVENTION

An embodiment of the present invention will now be described.

The non-aqueous ink composition for an ink jet according to one embodiment of the present invention is prepared by dispersing a pigment in a non-aqueous solvent by using a dispersant. The non-aqueous solvent denotes the general solvents other than water. At least 70% by weight of the entire non-aqueous solvent is a vegetable oil. Incidentally, the expression “%” used herein denotes “% by weight” unless otherwise specified.

The vegetable oil includes, for example, a soybean oil, a rapeseed oil, a corn oil, a linseed oil, a safflower oil, and a coconut oil. The present inventors have found that it is highly desirable to use these vegetable oils because these vegetable oils do not swell or markedly deform the PP film. In order to obtain a effect thereof, at least 70% by weight of the entire non-aqueous solvent should be the vegetable oils. The vegetable oils can be used singly or in the form of a mixture of a plurality of different kinds of vegetable oils. The ink composition in which the entire amount of the non-aqueous solvent is formed of vegetable oils is advantageous in that substantial damage is not done to the resin film.

The non-aqueous solvent may contain ester series solvent having 22 or less carbon atom or a liquid paraffin having an average molecular weight not larger than 340, or both, unless the ester series solvent and/or the liquid paraffin occupy more than 30% by weight of the non-aqueous solvent. In the case of using a non-aqueous solvent containing at least one of the prescribed ester series solvent and the liquid paraffin, it is possible to further lower the viscosity of the ink composition.

The ester series solvents having 22 or less carbon atoms include, for example, 2-ethyl hexyl isononanoate, isononyl isononanoate, isodecyl isononanoate, isotridecyl isononanoate, methyl laurate, ethyl laurate, isopropyl laurate, methyl myristate, ethyl myristate, isopropyl myristate, methyl palmitate, ethyl palmitate, isopropyl palmitate, methyl oleate, ethyl oleate, isopropyl oleate, methyl linoleate, ethyl linoleate, isopropyl linoleate, methyl isostearate, ethyl isostearate, isopropyl isostearate, methyl soybean oil, ethyl soybean oil, isopropyl soybean oil, 2-ethyl hexyl succinate, diethyl adipate, diisopropyl adipate, diethyl sebacate, and diisopropyl sebacate.

The ester series solvents having 22 or less carbon atoms, which are exemplified above, can be used singly or in the form of a mixture of a plurality of different kinds of the ester series solvents.

The liquid paraffin having an average molecular weight not larger than 340 includes, for example, Moresco white P-40, P-55, P-60, P-70; and Moresco violence U-6, U-7, which are manufactured by Matsumura Petroleum Research Laboratory. These liquid paraffin materials can be used singly or in the form of a mixture of a plurality of different kinds of liquid paraffin materials.

In some cases, it is possible to use in combination both the ester series solvents having 22 or less carbon atoms and the liquid paraffin having an average molecular weight not larger than 340. Further, it is possible for the non-aqueous solvent to further contain an alcohol series solvent, if the amount of the alcohol series solvent is not larger than 10% by weight of the entire non-aqueous solvent. The alcohol series solvents include, for example, isomyristyl alcohol, isopalmityl alcohol, isostearyl alcohol, and oleyl alcohol. Where such an alcohol is contained in the non-aqueous solvent, the range of the materials that can be added to the ink composition can be broadened.

The non-aqueous ink composition for an ink jet according to the embodiment of the present invention can be prepared by dispersing a pigment in the non-aqueous solvent described above by using a dispersant.

The pigment includes, for example, a pigment capable of absorbing light. The light absorbing pigment includes, for example, carbon-based pigments such as a carbon black, a carbon refined, and carbon nano tubes; metal oxide pigments such as iron black, cobalt blue, zinc oxide, titanium oxide, chromium oxide, and iron oxide; sulfide pigments such as zinc sulfide; phthalocyanine series pigments; pigments formed of metal salts such as sulfate, carbonate, silicate and phosphate; and pigments formed of a metal powder such as an aluminum powder, a bronze powder and a zinc powder.

It is also possible to use organic pigments including, for example, dye chelate such as a basic dye chelate or an acidic dye chelate; nitroso pigments such as a nitro pigment, aniline black, and naphthol green B; azo pigments including an azo lake, an insoluble azo pigment, a condensed azo pigment and a chelate azo pigment such as Bordeaux 10B, lake red 4R and chromophthal red; lake pigments such as piecock blue lake and rhodamine lake; phthalocyanine pigments such as phthalocyanine blue; polycyclic pigments such as perylene pigment, perinone pigment, anthraquinone pigment, quinacridone pigment, dioxane pigment, thio indigo pigment, isoindolinone pigment and quinophlanone pigment; threne pigments such as thio indigo red and indanthrone blue; quinacridone pigment; quinacridine pigment and isoindolinone pigment.

The pigment that can be used in a black ink includes, for example, Raven 5750, Raven 5250, Raven 5000, Raven 3500, Raven 1255, Raven 700, which are manufactured by Columbia Inc.; Regal 400R, Regal 330R, Regal 660R, Mogul L, Monarch 700, Monarch 800, Monarch 880, Monarch 900, Monarch 1000, Monarch 1100, Monarch 1300, Monarch 1400, which are manufactured by Cabot Inc.; No. 2300, No. 900, MCF 88, No. 33, No. 40, No. 45, No. 52, MA 7, MA 8, MA 100, No. 2200B, which are manufactured by Mitsubisi Chemical Co., ltd.; Color Black FW1, Color Black FW2, Color Black FW2V, Color Black FW18, Color Black FW200, Color Black S150, Color Black S160, Color Black S170, Printex 35, Printex 45, Printex U, Printex V, Printex 140U, Special Black 6, Special Black 5, Special Black 4A, and Special Black 4.

The pigment that can be used in the yellow ink includes, for example, Yellow 128, C.I. Pigment yellow 129, C.I. Pigment yellow 151, C.I. Pigment yellow 154, C.I. Pigment yellow 1, C.I. Pigment yellow 2, C.I. Pigment yellow 3, C.I. Pigment yellow 12, C.I. Pigment yellow 13, C.I. Pigment yellow 14C, C.I. Pigment yellow 16, C.I. Pigment yellow 17, C.I. Pigment yellow 73, C.I. Pigment yellow 74, C.I. Pigment yellow 75, C.I. Pigment yellow 83, C.I. Pigment yellow 93, C.I. Pigment yellow 95, C.I. Pigment yellow 97, C.I. Pigment yellow 98, C.I. Pigment yellow 114, and C.I. Pigment.

The pigment that can be used in the magenta ink includes, for example, C.I. Pigment Red 122, C.I. Pigment Red 123, C.I. Pigment Red 168, C.I. Pigment Red 184, C.I. Pigment Red 202, C.I. Pigment Red 5, C.I. Pigment Red 7, C.I. Pigment Red 12, C.I. Pigment Red 48(Ca), C.I. Pigment Red 48(Mn), C.I. Pigment Red 57(Ca), C.I. Pigment Red 57:1, and C.I. Pigment Red 112.

Further, the pigment that can be used in the cyan ink includes, for example, C.I. Pigment Blue 15:3, C.I. Pigment Blue 15:34, C.I. Pigment Blue 16, C.I. Pigment Blue 22, C.I. Pigment Blue 60, C.I. Pigment Blue 1, C.I. Pigment Blue 2, C.I. Pigment Blue 3, C.I. Vat Blue 4, and C.I. Vat Blue 60.

In general, each of the pigments exemplified above is dispersed in the non-aqueous solvent in an amount of about 1 to 25% by weight of the entire ink composition.

The dispersant for the pigment that is generally used in the non-aqueous dispersion medium can be used as the dispersant for dispersing the pigment in the solvent. An optional dispersant for the pigment can be used as far as the dispersant is compatible with a non-aqueous organic solvent so as to permit the pigment to be dispersed with a high stability in the form of fine particles. To be more specific, the dispersant includes, for example, sorbitan fatty acid esters such as sorbitan monooleate, sorbitan monolaurate, sorbitan sesquioleate, and sorbitan oleate; polyoxyethylene sorbitan fatty acid esters such as polyoxyethylene sorbitan monostearate, and polyoxyethylene sorbitan monooleate; polyethylene glycol fatty acid esters such as polyoxyethylene monostearate and polyethylene glycol diisocyanate; polyoxyethylene alkyl phenyl ethers such as polyoxyethylene nonyl phenyl ether and polyoxyethylene octyl phenyl ether; and nonionic surfactants such as aliphatic diethanol amide series.

It is also possible to use a polymer series dispersant. In this case, polymer compounds having a molecular weight not smaller than 1000 can be suitably used as the dispersant. To be more specific, the polymer series dispersant includes, for example, a styrene-maleic acid resin, a styrene-acrylic resin, rosin, BYK-112 and 116, which are acrylic polymer compounds manufactured by Big Chemie Inc., BYK-160, 162, 164 and 182, which are urethane series polymer compounds manufactured by Big Chemie Inc., EFKA-47 and LP-4050, which are urethane series polymer dispersants manufactured by EFKA Inc., EFKA-4300, which is a polyacrylate series polymer dispersant manufactured by EFKA Inc., Solsparse 13940, which is a polyester amine series polymer compound manufactured by LUBRIZOL JAPAN LMITED, Solsparse 17000 and 18000, which are aliphatic amine series polymer compounds manufactured by LUBRIZOL JAPAN LMITED, and Solsparse 22000, 24000 and 28000, which are polyester series polymer compounds manufactured by LUBRIZOL JAPAN LMITED.

The dispersant may be contained in the ink composition in an amount of about 25 to 200% by weight of the pigment. In this case, the dispersant is capable of sufficiently exhibiting the dispersing effect thereof.

In preparing the non-aqueous ink composition for ink jet according to the embodiment of the present invention, the pigment and the dispersant are mixed first with a prescribed non-aqueous solvent, followed by applying a dispersing treatment to the mixture by using a dispersing apparatus such as a bead mill. Then, the pigment agglomerate, etc. is removed by using, for example, a filter so as to obtain a desired ink composition.

The present invention will now be described more in detail with reference to Examples of the present invention. Needless to say, the present invention is not limited to the following Examples, as far as the technical scope of the present invention is not deviated.

Prepared were vegetable oils, ester series solvents having 22 or less carbon atoms and liquid paraffin materials having a molecular weight not larger than 340 as the components constituting the non-aqueous solvent. Tables 1, 2 and 3 show the vegetable oils used (solvents a to f), ester series solvents used (solvents g to i), and liquid paraffin materials used (solvents j to m), respectively. Also prepared was oleyl alcohol (solvent n) as an alcohol series solvent:

TABLE 1

| Solvent | Name |
|---|---|
| a | Soybean oil |
| b | Linseed oil |
| c | Safflower oil |
| d | Rapeseed oil |
| e | Corn oil |
| f | Coconut oil |

TABLE 2

| | | Number of |
|---|---|---|
| Solvent | Name | carbon atoms |
| g | Isotridecyl | 22 |
| | isononanoate | |
| h | Ethyl isostearate | 20 |
| i | Isononyl | 18 |
| | isononanoate | |

TABLE 3

| | | Average |
|---|---|---|
| Solvent | Name | molecular weight |
| j | Moresco white P-40 | 250 |
| k | Moresco white P-60 | 300 |
| l | Moresco white P-70 | 322 |
| m | Moresco white P-85 | 340 |

### EXAMPLE 1

A mixture containing 91 parts by weight of soybean oil as a non-aqueous solvent, 5 parts by weight of channel carbon black (i.e., C.I. No. 77266: special black 4A manufactured by Dexa Inc.) as a pigment, and 4 parts by weight of Disperbyk 116 manufactured by Big Chemie Inc. as a dispersant, was dispersed by using a bead mill. Then, a pigment agglomerate, etc. was removed from the dispersion by using a filter of 3 μm so as to obtain a non-aqueous ink composition for ink jet for Example 1.

### EXAMPLES 2 TO 9

A non-aqueous ink composition for an ink jet for each of Examples 2 to 9 was prepared as in Example 1, except that used were the solvents shown in Table 4. In the ink composition for each of Examples 1 to 9, the total amount (100%) of the non-aqueous solvent was formed of a single kind of the vegetable oil or a mixture of two different kinds of vegetable oils.

TABLE 4

| Example | Mixing ratio | | | | | |
|---|---|---|---|---|---|---|
| No. | a | b | c | d | e | f |
| 1 | 100 | | | | | |
| 2 | 50 | 50 | | | | |
| 3 | | 100 | | | | |
| 4 | | 75 | 25 | | | |
| 5 | | | 100 | | | |
| 6 | | | 25 | 75 | | |
| 7 | | | | 100 | | |
| 8 | | | | | 100 | |
| 9 | | | | | | 100 |

The viscosity of the non-aqueous ink composition at 25° C., the discharging stability of the non-aqueous ink composition in the recording operation, and the damage done by the non-aqueous ink composition to the resin film were examined for the non-aqueous ink composition for an ink jet obtained in each of Example 1 to 9.

A viscometer (TV-33 type viscometer manufactured by Toki Sangyo K.K.) was used for measuring the viscosity of the ink composition at 25° C. In view of, for example, the aspect of facilitating the supply of the ink composition to the ink jet head, it is desirable for the viscosity of the ink composition at 25° C. to be not higher than about 100 mPa·sec.

For evaluating the discharging stability of the non-aqueous ink composition, an image was formed on an ordinary paper sheet (i.e., a copying paper sheet P-50S manufactured by Toshiba Corporation) by using an image evaluating apparatus to which was mounted a piezo type ink jet head manufactured by Toshiba TEC K.K. (i.e., type CB1 having 318 nozzles). In discharging the ink composition, the ink composition within the head was heated in accordance with the viscosity of the ink composition so as to lower the viscosity of the ink composition. Incidentally, when the ink composition is discharged from the head, it is desirable for the temperature of the ink composition to be not higher than 70° C., more desirably to be not higher than 55° C., and furthermore desirably to be not higher than 40° C. in order to lower the energy required for heating the ink composition within the head. Ink images were formed by using all of the 318 nozzles arranged within the ink jet head so as to obtain a printed image. The dropping of the image was visually judged in respect of the printed image thus formed so as to confirm whether or not it was possible to form a printed image free from the dropping of the image.

In order to examine the damage done by the non-aqueous ink composition to the resin film, a solid image was printed over an area of ⅓ of an A4 size paper sheet, by using a non-aqueous ink composition for ink jet for each of Examples 1 to 9. The printed image thus obtained was housed in resin files formed of a resin film, i.e., an A4 REFILE (La-A21N) manufactured by Kokuyo K.K. and a transparent pocket file (No. 103) manufactured by Kingjim Inc., and stored for 10 days under room temperature (25° C.). Then, the breakage of the resin file caused by the deformation of the resin film was evaluated by the standards given below:

⊚: deformation was not observed;

◯: deformation was not observed, but, speck-like fine recesses were observed;

Δ: deformation not larger than 1 mm was observed in the resin film;

X: deformation not smaller than 1 mm was observed in the resin film so as to break the resin file.

The damage done to the resin film, which is denoted by the marks “⊚”, “◯” and “Δ”, fall within the allowable range. Table 5 shows the experimental data on the damage done to the resin film:

TABLE 5

| Example | Viscosity | Ink | Damage done |
|---|---|---|---|
| No. | (25° C.) | temperature | to film |
| 1 | 72.8 | 65° C. | ⊚ |
| 2 | 65.6 | 65° C. | ⊚ |
| 3 | 58.1 | 60° C. | ⊚ |
| 4 | 61.2 | 60° C. | ⊚ |
| 5 | 70.2 | 65° C. | ⊚ |
| 6 | 73.7 | 65° C. | ⊚ |
| 7 | 74.9 | 65° C. | ⊚ |
| 8 | 74.1 | 65° C. | ⊚ |
| 9 | 67.7 | 65° C. | ⊚ |

As shown in Table 5, the resin film was not deformed at all in the case of the ink composition for Examples 1 to 9 because the entire non-aqueous solvent was formed of vegetable oils in these Examples. Also, a printed image free from the dropping of the image was formed in the case of using any of the ink compositions for Examples 1 to 9 by discharging the ink compositions while heating the head to temperatures not higher than 65° C.

### EXAMPLES 10 TO 36

An ink composition was prepared by using a mixture of a vegetable oil and an ester series solvent having 22 or less carbon atoms as a non-aqueous solvent so as to examine the characteristics of the ink composition. To be more specific, the ink compositions for Examples 10 to 36 were prepared as in Example 1, except that the vegetable oils shown in Table 1 and the ester series solvents shown in Table 2 were mixed in the mixing ratios (% by weight) shown in Table 6:

TABLE 6

| | |
|---|---|
| Example | Mixing ratio |

| No. | a | b | c | g | h | i |
|---|---|---|---|---|---|---|
| 10 | 90 | | | 10 | | |
| 11 | 80 | | | 20 | | |
| 12 | 70 | | | 30 | | |
| 13 | 90 | | | | 10 | |
| 14 | 80 | | | | 20 | |
| 15 | 70 | | | | 30 | |
| 16 | 90 | | | | | 10 |
| 17 | 80 | | | | | 20 |
| 18 | 70 | | | | | 30 |
| 19 | | 90 | | 10 | | |
| 20 | | 80 | | 20 | | |
| 21 | | 70 | | 30 | | |
| 22 | | 90 | | | 10 | |
| 23 | | 80 | | | 20 | |
| 24 | | 70 | | | 30 | |
| 25 | | 90 | | | | 10 |
| 26 | | 80 | | | | 20 |
| 27 | | 70 | | | | 30 |
| 28 | | | 90 | 10 | | |
| 29 | | | 80 | 20 | | |
| 30 | | | 70 | 30 | | |
| 31 | | | 90 | | 10 | |
| 32 | | | 80 | | 20 | |
| 33 | | | 70 | | 30 | |
| 34 | | | 90 | | | 10 |
| 35 | | | 80 | | | 20 |
| 36 | | | 70 | | | 30 |

The viscosity of the non-aqueous ink composition at 25° C., the discharging stability of the non-aqueous ink composition in the recording stage and the damage done by the non-aqueous ink composition to the film were examined in respect of the ink compositions for Examples 10 to 36 by the methods described previously. Table 7 shows the results:

TABLE 7

| Example | Viscosity | Ink | Damage done |
|---|---|---|---|
| No. | (25° C.) | temperature | to film |
| 10 | 58.2 | 60° C. | ◯ |
| 11 | 47.4 | 55° C. | ◯ |
| 12 | 37.2 | 50° C. | Δ |
| 13 | 54.0 | 60° C. | ◯ |
| 14 | 40.8 | 50° C. | ◯ |
| 15 | 32.9 | 45° C. | Δ |
| 16 | 51.6 | 55° C. | ◯ |
| 17 | 38.2 | 50° C. | ◯ |
| 18 | 29.7 | 45° C. | Δ |
| 19 | 50.2 | 55° C. | ◯ |
| 20 | 40.0 | 50° C. | ◯ |
| 21 | 32.6 | 45° C. | Δ |
| 22 | 45.9 | 55° C. | ◯ |
| 23 | 36.7 | 50° C. | ◯ |
| 24 | 29.2 | 45° C. | Δ |
| 25 | 43.4 | 55° C. | ◯ |
| 26 | 34.5 | 50° C. | ◯ |
| 27 | 26.1 | 40° C. | Δ |
| 28 | 57.8 | 60° C. | ◯ |
| 29 | 47.2 | 55° C. | ◯ |
| 30 | 37.1 | 50° C. | Δ |
| 31 | 53.2 | 55° C. | ◯ |
| 32 | 40.4 | 50° C. | ◯ |
| 33 | 32.7 | 45° C. | Δ |
| 34 | 50.5 | 55° C. | ◯ |
| 35 | 37.8 | 50° C. | ◯ |
| 36 | 29.5 | 45° C. | Δ |

As shown in Table 7, the damage done by the non-aqueous ink composition to the resin film fell within the allowable range in each of the ink compositions for Examples 10 to 36. A comparison between Table 5 and Table 7 indicates that the viscosity of the ink composition at 25° C. can be further lowered in the case where the non-aqueous solvent further contains ester series solvents having 22 or less carbon atoms in addition to the vegetable oil. It should be noted, however, that the viscosity of the ink composition and the damage done to the resin film have a trade off relationship such that, if the amount of the ester series solvent is increased so as to decrease the amount of the vegetable oil, the damage done by the non-aqueous ink composition to the resin film tends to be increased.

It should also be noted that a printed image free from the dropping of the image was formed in the case of using any of the ink compositions by discharging the ink compositions in the head while heating to 60° C. or lower.

### EXAMPLES 37 TO 72

An ink composition was prepared by using a mixture containing a vegetable oil, and a liquid paraffin having an average molecular weight not larger than 340 as a non-aqueous solvent so as to examine the characteristics of the ink composition. To be more specific, the ink compositions for Examples 37 to 72 were prepared as in Example 1, except that the vegetable oils shown in Table 1, and the liquid paraffin materials shown in Table 3 were mixed in the mixing ratios (% by weight) shown in Table 8:

TABLE 8

| Example | Mixing ratio | | | | | | |
|---|---|---|---|---|---|---|---|
| No. | a | b | c | j | k | l | m |
| 37 | 90 | | | 10 | | | |
| 38 | 80 | | | 20 | | | |
| 39 | 70 | | | 30 | | | |
| 40 | 90 | | | | 10 | | |
| 41 | 80 | | | | 20 | | |
| 42 | 70 | | | | 30 | | |
| 43 | 90 | | | | | 10 | |
| 44 | 80 | | | | | 20 | |
| 45 | 70 | | | | | 30 | |
| 46 | 90 | | | | | | 10 |
| 47 | 80 | | | | | | 20 |
| 48 | 70 | | | | | | 30 |
| 49 | | 90 | | 10 | | | |
| 50 | | 80 | | 20 | | | |
| 51 | | 70 | | 30 | | | |
| 52 | | 90 | | | 10 | | |
| 53 | | 80 | | | 20 | | |
| 54 | | 70 | | | 30 | | |
| 55 | | 90 | | | | 10 | |
| 56 | | 80 | | | | 20 | |
| 57 | | 70 | | | | 30 | |
| 58 | | 90 | | | | | 10 |
| 59 | | 80 | | | | | 20 |
| 60 | | 70 | | | | | 30 |
| 61 | | | 90 | 10 | | | |
| 62 | | | 80 | 20 | | | |
| 63 | | | 70 | 30 | | | |
| 64 | | | 90 | | 10 | | |
| 65 | | | 80 | | 20 | | |
| 66 | | | 70 | | 30 | | |
| 67 | | | 90 | | | 10 | |
| 68 | | | 80 | | | 20 | |
| 69 | | | 70 | | | 30 | |
| 70 | | | 90 | | | | 10 |
| 71 | | | 80 | | | | 20 |
| 72 | | | 70 | | | | 30 |

The viscosity of the non-aqueous ink composition at 25° C., the discharging stability of the non-aqueous ink composition in the recording stage and the damage done by the non-aqueous ink composition to the resin film were examined in respect of the ink compositions for Examples 37 to 72 by the methods described previously. Table 9 shows the results:

TABLE 9

| Example | Viscosity | Ink | Damage done |
|---|---|---|---|
| No. | (25° C.) | temperature | to film |
| 37 | 51.6 | 55° C. | ◯ |
| 38 | 38.2 | 50° C. | ◯ |
| 39 | 29.7 | 45° C. | Δ |
| 40 | 59.5 | 60° C. | ◯ |
| 41 | 49.6 | 55° C. | ◯ |
| 42 | 42.4 | 55° C. | Δ |
| 43 | 59.7 | 60° C. | ◯ |
| 44 | 50.0 | 55° C. | ◯ |
| 45 | 43.2 | 55° C. | Δ |
| 46 | 66.5 | 65° C. | ◯ |
| 47 | 60.8 | 60° C. | ◯ |
| 48 | 55.7 | 60° C. | Δ |
| 49 | 43.4 | 55° C. | ◯ |
| 50 | 34.5 | 50° C. | ◯ |
| 51 | 26.1 | 40° C. | Δ |
| 52 | 49.0 | 55° C. | ◯ |
| 53 | 42.6 | 55° C. | ◯ |
| 54 | 36.0 | 50° C. | Δ |
| 55 | 49.2 | 55° C. | ◯ |
| 56 | 43.0 | 55° C. | ◯ |
| 57 | 36.8 | 50° C. | Δ |
| 58 | 53.7 | 60° C. | ◯ |
| 59 | 50.1 | 55° C. | ◯ |
| 60 | 47.8 | 55° C. | Δ |
| 61 | 50.5 | 55° C. | ◯ |
| 62 | 37.8 | 50° C. | ◯ |
| 63 | 29.5 | 45° C. | Δ |
| 64 | 58.6 | 60° C. | ◯ |
| 65 | 49.3 | 55° C. | ◯ |
| 66 | 42.2 | 55° C. | Δ |
| 67 | 58.8 | 60° C. | ◯ |
| 68 | 49.7 | 55° C. | ◯ |
| 69 | 43.0 | 55° C. | Δ |
| 70 | 65.8 | 65° C. | ◯ |
| 71 | 60.2 | 60° C. | ◯ |
| 72 | 55.5 | 60° C. | Δ |

As shown in Table 9, the damage done by the non-aqueous ink composition to the resin film fell within the allowable range in each of the ink compositions for Examples 37 to 72. A comparison between Table 5 and Table 9 indicates that the viscosity of the ink composition at 25° C. can be lowered in the case where the non-aqueous solvent further contains a prescribed liquid paraffin material having an average molecular weight not larger than 340. It should be noted, however, that the viscosity of the ink composition and the damage done by the ink composition to the resin film have a trade off relationship such that, if the amount of the liquid paraffin is increased so as to decrease the amount of the vegetable oil, the damage done by the ink composition to the resin film tends to be increased.

It should also be noted that a printed material free from the dropping of the image was formed in the case of using any of the ink compositions by discharging the ink compositions in the head while heating to 65° C. or lower.

### EXAMPLES 73 TO 75

An ink composition was prepared by using a mixture containing a vegetable oil, an ester series solvent having 22 or less carbon atoms, and a liquid paraffin having an average molecular weight not larger than 340 as a non-aqueous solvent so as to examine the characteristics of the ink composition. To be more specific, the ink compositions for Examples 73 to 75 were prepared as in Example 1, except that the vegetable oils shown in Table 1, the ester series solvents shown in Table 2, and the liquid paraffin materials shown in Table 3 were mixed in the mixing amounts (% by weight) shown in Table 10:

TABLE 10

| Example | Mixing ratio | | | | |
|---|---|---|---|---|---|
| No. | a | b | c | i | j |
| 73 | 90 | | | 5 | 5 |
| 74 | | 80 | | 15 | 5 |
| 75 | | | 70 | 10 | 20 |

The viscosity of the ink composition at 25° C., the discharging stability of the ink composition in the recording stage and the damage done by the ink composition to the resin film were examined in respect of the ink compositions for Examples 73 to 75 by the methods described previously. Table 11 shows the results:

TABLE 11

| Example | Viscosity | Ink | Damage done |
|---|---|---|---|
| No. | (25° C.) | temperature | to film |
| 73 | 51.6 | 55° C. | ◯ |
| 74 | 34.5 | 50° C. | ◯ |
| 75 | 32.7 | 45° C. | Δ |

As shown in Table 11, the damage by the ink composition done to the resin film fell within the allowable range in each of the ink compositions for Examples 73 to 75. A comparison between Table 5 and Table 11 indicates that the viscosity of the ink composition at 25° C. can be lowered in the case where the non-aqueous solvent further contains both a prescribed ester series solvent and the liquid paraffin material. It should be noted, however, that the viscosity of the ink composition and the damage done by the ink composition to the resin film are in the trade off relationship such that, if the amount of the vegetable oil is decreased, the damage done by the ink composition to the resin film tends to be increased.

It should also be noted that a printed material free from the dropping of the image was formed in the case of using any of the ink compositions by discharging the ink compositions in the head while heating to 55° C. or lower.

### EXAMPLES 76 TO 78

An ink composition was prepared as in Example 1, except that the non-aqueous solvent was prepared by mixing a vegetable oil, an ester series solvent having 22 or less carbon atoms, and oleyl alcohol in the mixing amounts (% by weight) shown in Table 12:

TABLE 12

| | |
|---|---|
| Example | Mixing ratio |

| No. | a | b | c | g | h | n |
|---|---|---|---|---|---|---|
| 76 | 76 | | | | 19 | 5 |
| 77 | | 76 | | 19 | | 5 |
| 73 | | | 76 | | 19 | 5 |

The viscosity of the ink composition at 25° C., the discharging stability of the ink composition in the recording stage and the damage done by the ink composition to the resin film were examined in respect of the ink compositions for Examples 76 to 78 by the methods described previously. Table 13 shows the results:

TABLE 13

| Example | Viscosity | Ink | Damage done |
|---|---|---|---|
| No. | (25° C.) | temperature | to film |
| 76 | 40.7 | 50° C. | ◯ |
| 77 | 40.1 | 50° C. | ◯ |
| 78 | 40.4 | 50° C. | ◯ |

As shown in Table 13, the damage done by the ink composition to the resin film fell within the allowable range in each of the ink compositions for Examples 76 to 78. A comparison between Table 7 and Table 13 indicates that the materials that can be added to the ink composition can be broadened in the case where the non-aqueous solvent further contains oleyl alcohol in addition to the ester series solvent, though a prominent improvement was not produced by the additional component of oleyl alcohol in any of the viscosity of the ink composition, the ink temperature and the damage done by the ink composition to the resin film.

It should also be noted that a printed material image free from the dropping of the image was formed in the case of using any of the ink compositions by discharging the ink compositions in the head s to 50° C. or lower.

### EXAMPLES 79 TO 81

Ink compositions for Examples 79 to 81 were prepared as in Example 1, except that the non-aqueous solvent was prepared by mixing a vegetable oil, a liquid paraffin having an average molecular weight not larger than 340 and oleyl alcohol in the mixing ratios (% by weight) shown in Table 14.

TABLE 14

| Example | Mixing ratio | | | | |
|---|---|---|---|---|---|
| No. | a | b | c | m | n |
| 79 | 90 | | | 5 | 5 |
| 80 | | 80 | | 15 | 5 |
| 81 | | | 70 | 25 | 5 |

The viscosity of the ink composition at 25° C., the discharging stability of the ink composition in the recording stage and the damage done by the ink composition to the resin film were examined in respect of the ink compositions for Examples 79 to 81 by the methods described previously. Table 15 shows the results:

TABLE 15

| Example | Viscosity | Ink | Damage done |
|---|---|---|---|
| No. | (25° C.) | temperature | to film |
| 79 | 66.7 | 65° C. | ◯ |
| 80 | 50.3 | 55° C. | ◯ |
| 81 | 55.7 | 60° C. | Δ |

As shown in Table 15, the damage done by the ink composition to the resin film fell within the allowable range in each of the ink compositions for Examples 79 to 81. A comparison between Table 9 and Table 15 indicates that the materials that can be added to the ink composition can be broadened in the case where the non-aqueous solvent further contains oleyl alcohol, though a prominent improvement was not produced by the additional component of oleyl alcohol in any of the viscosity of the ink composition, the ink temperature and the damage done by the ink composition to the resin film.

It should also be noted that a printed material free from the dropping of the image was formed in the case of using any of the ink compositions by discharging the ink compositions in the head while heating to 65° C. or lower.

### EXAMPLES 82 TO 84

Ink compositions for Examples 82 to 84 were prepared as in Example 1, except that the non-aqueous solvent was prepared by mixing a vegetable oil, an ester series solvent having 22 or less carbon atoms, a liquid paraffin having an average molecular weight not larger than 340, and oleyl alcohol in the mixing amounts (% by weight) shown in Table 16.

TABLE 16

| | |
|---|---|
| Example | Mixing ratio |

| No. | a | b | c | i | j | n |
|---|---|---|---|---|---|---|
| 82 | 85 | | | 5 | 5 | 5 |
| 83 | | 76 | | 14 | 5 | 5 |
| 84 | | | 70 | 10 | 15 | 5 |

The viscosity of the ink composition at 25° C., the discharging stability of the ink composition in the recording stage and the damage done by the ink composition to the resin film were examined in respect of the ink compositions for Examples 82 to 84 by the methods described previously. Table 17 shows the results:

TABLE 17

| Example | Viscosity | Ink | Damage done |
|---|---|---|---|
| No. | (25° C.) | temperature | to film |
| 82 | 51.1 | 55° C. | ◯ |
| 83 | 34.9 | 50° C. | ◯ |
| 84 | 33.4 | 45° C. | Δ |

As shown in Table 17, the damage done by the ink composition to the resin film fell within the allowable range in each of the ink compositions for Examples 82 to 84. A comparison between Table 11 and Table 17 indicates that the materials that can be added to the ink composition can be broadened in the case where the non-aqueous solvent further contains oleyl alcohol, though a prominent improvement was not produced by the additional component of oleyl alcohol in any of the viscosity of the ink composition, the ink temperature and the damage done by the ink composition to the resin film.

It should also be noted that a printed material free from the dropping of the image was formed in the case of using any of the ink compositions by discharging the ink compositions in the head while heating to 55° C. or lower.

### COMPARATIVE EXAMPLES 1 TO 21

Ink compositions for Comparative Examples 1 to 21 were prepared as in Example 1, except that the non-aqueous solvent was prepared by mixing a vegetable oil, an ester series solvent having 22 or less carbon atoms, and a liquid paraffin having an average molecular weight not larger than 340 in the mixing amounts (% by weight) shown in Table 18.

TABLE 18

| | |
|---|---|
| Comparative | Mixing ratio |

| Example No. | a | b | c | g | h | i | j | k | l | m |
|---|---|---|---|---|---|---|---|---|---|---|
| 1 | 60 | | | 40 | | | | | | |
| 2 | 60 | | | | 40 | | | | | |
| 3 | 60 | | | | | 40 | | | | |
| 4 | | 60 | | 40 | | | | | | |
| 5 | | 60 | | | 40 | | | | | |
| 6 | | 60 | | | | 40 | | | | |
| 7 | | | 60 | 40 | | | | | | |
| 8 | | | 60 | | 40 | | | | | |
| 9 | | | 60 | | | 40 | | | | |
| 10 | 60 | | | | | | 40 | | | |
| 11 | 60 | | | | | | | 40 | | |
| 12 | 60 | | | | | | | | 40 | |
| 13 | 60 | | | | | | | | | 40 |
| 14 | | 60 | | | | | 40 | | | |
| 15 | | 60 | | | | | | 40 | | |
| 16 | | 60 | | | | | | | 40 | |
| 17 | | 60 | | | | | | | | 40 |
| 18 | | | 60 | | | | 40 | | | |
| 19 | | | 60 | | | | | 40 | | |
| 20 | | | 60 | | | | | | 40 | |
| 21 | | | 60 | | | | | | | 40 |

The viscosity of the ink composition at 25° C., the discharging stability of the ink composition in the recording stage and the damage done by the ink composition to the resin film were examined in respect of the ink compositions for Comparative Examples 1 to 21 by the methods described previously. Table 19 shows the results:

TABLE 19

| Comparative | Viscosity | Ink | Dame done |
|---|---|---|---|
| Example No. | (25° C.) | temperature | to film |
| 1 | 30.3 | 45° C. | X |
| 2 | 26.5 | 40° C. | X |
| 3 | 24.0 | 35° C. | X |
| 4 | 28.4 | 40° C. | X |
| 5 | 24.6 | 40° C. | X |
| 6 | 22.0 | 35° C. | X |
| 7 | 30.2 | 45° C. | X |
| 8 | 26.4 | 40° C. | X |
| 9 | 23.9 | 35° C. | X |
| 10 | 24.0 | 35° C. | X |
| 11 | 35.8 | 50° C. | X |
| 12 | 36.8 | 50° C. | X |
| 13 | 50.0 | 55° C. | X |
| 14 | 22.0 | 35° C. | X |
| 15 | 33.3 | 45° C. | X |
| 16 | 34.3 | 50° C. | X |
| 17 | 44.5 | 55° C. | X |
| 18 | 23.9 | 35° C. | X |
| 19 | 35.7 | 50° C. | X |
| 20 | 36.7 | 50° C. | X |
| 21 | 49.9 | 55° C. | X |

As shown in Table 19, it was impossible to suppress the damage done by the ink composition to the resin film in the case where the vegetable oil content of the non-aqueous solvent was set at 60%, with the result that the transparent film used for forming the resin file was deformed in the case of using the ink composition for each of Comparative Examples 1 to 21.

As apparent from the experimental data, it has been confirmed that it is possible to obtain an ink composition that is satisfactory in any of the viscosity at 25° C., the discharging stability in the recording stage, and the damage done to the resin film by allowing at least 70% of the non-aqueous solvent is the vegetable oil.

Similar results were obtained in the case of the ink composition prepared by changing the kind of the pigment contained in the non-aqueous solvent. To be more specific, it has been found possible to obtain an ink composition that permits suppressing the damage done by the ink composition to the resin film used for forming a resin file by allowing at least 70% by weight of the non-aqueous solvent is the vegetable oil in the case of an yellow ink composition prepared by using Hostaperm Yellow H4G (Pig. Y. 151, Clariant) as a pigment, a magenta ink composition prepared by using Hospaterm Pink E-WD (Pig. P. 122, Clariant) as a pigment, and a cyan ink composition prepared by using PV Fast Blue 2GLSP (Pig. Blue. 15:3, Clariant) as a pigment. In addition, a good discharging stability of the ink composition has been secured. It was possible to further suppress the damage done by the ink composition to the resin film used for forming the resin file by allowing the entire non-aqueous solvent to be formed of vegetable oils.

According to an aspect of the present invention, it is possible to provide a non-aqueous ink composition for ink jet, which does not break the transparent file generally used in the office or the home and which exhibits a high discharging stability.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A non-aqueous ink composition for an ink jet, comprising a pigment, a dispersant and a non-aqueous solvent, wherein at least 70% by weight of the non-aqueous solvent is vegetable oil.

2. The non-aqueous ink composition for an ink jet according to claim 1, wherein the vegetable oil is selected from the group consisting of a soybean oil, a rapeseed oil, a corn oil, a linseed oil, a safflower oil, and a coconut oil.

3. The non-aqueous ink composition for an ink jet according to claim 1, wherein 100% by weight of the non-aqueous solvent is the vegetable oil.

4. The non-aqueous ink composition for an ink jet according to claim 1, wherein at least a part of the remainder of the non-aqueous solvent is formed of at least one of an ester series solvent having 22 or less carbon atoms and a liquid paraffin having an average molecular weight not larger 340.

5. The non-aqueous ink composition for an ink jet according to claim 4, wherein the remainder of the non-aqueous solvent is formed of an ester series solvent having 22 or less carbon atoms.

6. The non-aqueous ink composition for an ink jet according to claim 4, wherein the remainder of the non-aqueous solvent is formed of a liquid paraffin having an average molecular weight not larger than 340.

7. The non-aqueous ink composition for an ink jet according to claim 4, further comprising an alcohol series solvent.
